(19) United States
(12) Patent Application Publication
(10) Pub. No.: US 2013/0098897 A1
(43) Pub. Date: Apr. 25, 2013

(54) Multi-curved Continuous Type Metal PTC Rapid Electric Heater

(71) Applicant: Ji HUANG, Shanghai (CN)

(72) Inventor: Ji HUANG, Shanghai (CN)

(21) Appl. No.: 13/281,131

(22) Filed: Oct. 25, 2011

(51) Int. Cl. H05B 3/10

(52) U.S. Cl. 219/548

(57) ABSTRACT

A multi-curved continuous type metal PTC rapid electric heater for used in the electric heating field comprises at least one electric heating device that has a metal PTC pipe that is enclosed by an electric heating pipe body. Two ends of an electric heating pipe body have a wiring terminal installed and a plurality heat radiating fans installed outside. The electric heating pipe body comprises at least four straight pipes and at least three C-shape pipes. Both ends of the C-shape pipe are connected to a straight pipe, which forms a curved electric heating pipe part. A multi-curved continuous type metal PTC rapid electric heater comprises at least two curved electric heating pipe parts in which the lower ends of neighboring straight pipes of two curved electric heating pipe parts are connected via a C-shape pipe.

### TECHNICAL FIELD

The present invention relates to afield of electrical heating. In particularly, it relates to electric heaters.

### BACKGROUND ART

Electric heaters are widely used in areas of small electrical heating appliances, temperature control systems, car heaters, airplane heaters, train heaters, ship heaters and so on.

As quality of life being improved in recent years, temperature control systems are widely used. In regarding temperature control systems, electric heaters not only provide supplemental heating functions, also provide the pre-heating function. For example, electric heaters can preheat anti-frozen liquid to help starting systems in case of cold environment, e.g., below −5 C. Temperature control systems are usually used in a closed space to frequently decrease or increase surrounding temperature for a long period of time.

The characteristics of electric heaters require graceful distribution of heat energy, efficient energy emission, small in size and easy for installation. Regarding these characteristics, the current electric heaters still need some improvements.

### DISCLOSURE OF THE INVENTION

The purpose of the present invention is to provide the multi-curved continuous type metal PTC rapid electric heater to solve the above mentioned technical concerns. The present invention resolves these technical concerns as follows:

A multi-curved continuous type metal PTC rapid electric heater comprises at least one electric heating device. A said electric heating device comprises a metal PTC pipe. A said metal PTC pipe is enclosed by an electric heating pipe body. Each of two ends of said electric heating pipe body has a wiring terminal. Multiple heat radiating fins are placed outside of a said electric heating pipe body. The characteristics of said electric heating pipe body comprise at least four straight pipes and at least three C-shape pipes.

The upper end of a said straight pipe is connected to one end of the C-shape pipe of which the opening of C-shape points downward. The other end of this C-shape pipe is connected to another straight pipe. This structure forms a curved electric heating pipe part.

An electric heating device comprises at least two said curved electric heating pipe parts. The lower ends of two neighboring straight pipes of two curved electric heating pipe parts are connected together via another C-shape pipe. The heat-conducting electric-insulating powder is filled between a metal PTC pipe and an electric heating pipe body.

Via a C-shape pipe, a multi-curved continuous type metal PTC rapid electric heater connects two straight pipes to form a curved electric heating pipe part which effectively combines two existing common electric heaters. Furthermore, via multiple C-shape pipes, it connects at least two curved electric heating pipe parts together to have better and stronger effect of heating. With this design, it only requires one multi-curved continuous type metal PTC rapid electric heater for a place that originally needs many common electric heaters. Also, there are two straight pipes in the ends of a curved electric heating pipe body, thus the two wiring terminals are located in the same side of a multi-curved continuous type metal PTC rapid electric heater. It helps wiring layout during the installation.

The number of said curved electric heating pipe parts may be 1 to 10.

There is no radiating fin outside a C-shape pipe to simplify production process and ensure ease of installation.

All of said C-shape pipes and said straight pipes in a said electric heating device are laid in the same plane. A multi-curved continuous type metal PTC rapid electric heater comprises at least two said electric heating devices which are laid sequentially in parallel, front to back along the thickness direction of C-shape pipes.

A said electric heating pipe body has at least two radiating tins. If more than one of said heating pipe parts are used, said electric heating pipe bodies of multi said electric heating devices that are laid in parallel, are inserted separately and simultaneously through at least two said radiating fins. Using radiating fins, this design can firmly hold at least two electric heating devices together to ease production and installation processes and make installation sturdy and neat.

The number of said electric heating devices is 1 to 12. All of these 1 to 12 electric heating devices are laid sequentially in parallel, front to hack along the thickness direction of said C-shape pipes.

### BRIEF DESCRIPTION OF THE DRAWINGS

FIG. 1 is a main view of a multi-curved continuous type metal PTC rapid electric heater in an embodiment;

FIG. 2 is a side view of a multi-curved continuous type metal PTC rapid electric heater in an embodiment.

### DETAILED DESCRIPTIONS OF THE PREFERRED EMBODIMENTS

In order to better understanding techniques, characteristics and objectives of the present invention, the following descriptions and the accompanying above figures further illustrate the present invention.

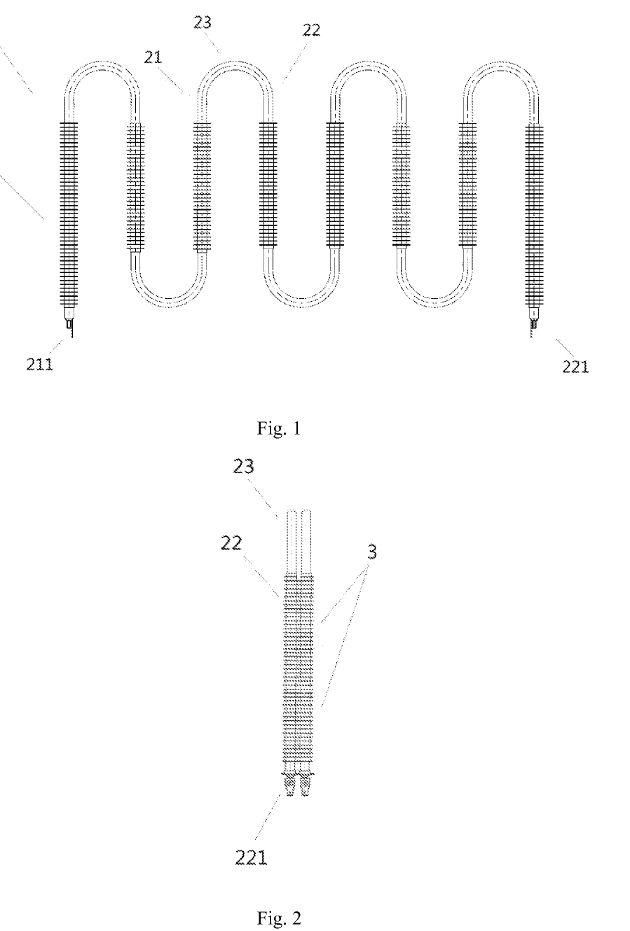

In reference of FIG. 1, a multi-curved continuous type metal PTC rapid electric heater 1 comprises at least one electric heating device 1. An electric heating device comprises a metal PTC pipe that is enclosed by an electric heating pipe body 2. Two ends of an electric heating pipe body 2 have respectively wiring terminals 211 and 221. Outside of an electric heating pipe body 2 has heat radiation fins in place. In an electric heating device 1, an electric heating pipe body 2 comprises at least four straight pipes 21 or 22 and at least three C-shape pipes 23. The top end of a straight pipe 21 is connected to one end of a C-shape pipe 23 of which the C opening points downward. The other end of a C-shape pipe 23 is connected to another straight pipe 22. This forms a curved electric heating pipe part. Multiple (at least two) curved electric heating pipe parts can be connected together by joining the bottom ends of two neighboring straight pipes via a C-shape pipe 23.

Comparing with common electric heating pipes, the metal PTC pipe has important technical advantages: Some portion of common electric heating pipes may generate high temperature to form partial open-circuit arc that can burn out or melt down portion of electric heater's protection sleeve to cause a fire. One feature of a metal PTC pipe is that when portion of pipe's temperature is raised, its electrical resistance is also increased to avoid burn out or melt down a pipe to ensure safety.

Via a C-shape pipe 23, a multi-curved continuous type metal PTC rapid electric heater combines two straight pipes 21, 22 together to form a curved electric heating pipe part which effectively accomplish of combining two common electric heaters. Via additional C-shape pipes 23, multiple (at least two) curved electric heating pipe parts can be also combined to further increase heating effect. Thus, a place that originally needs installing many common electric heaters may need installing only one multi-curved continuous type metal PTC rapid electric heater in this design. Since there are two straight pipes 21 and 22 in a curved electric heating pipe part, thus two wiring terminals 211 and 221 are located at the same side of a multi-curved continuous type metal PTC rapid electric heater. It helps wiring layout work during actual implementation. The number of curved electric heating pipe parts can be 1 to 10.

There is no radiating fin placed outside a C-shape pipe 23. All of C-shape pipes 23, straight pipes 21 and 22 are laid in the same plane. This design can simplify the production process and ensure ease of installation.

In reference of FIGS. 1 and 2, a multi-curved continuous type metal PTC rapid electric heater comprises at least one electric heating device 1. At least two electric heating devices are laid sequentially in parallel, front to back along the thickness direction of C-shape pipes 23. There are at least two radiating fins 3 placed on an electric heating pipe body 2. The electric heating pipe bodies 2 of at least two electric heating devices 1 that are laid sequentially in parallel, are inserted separately and simultaneously through at least two radiating fins 3. Using radiating fins 3, this design can place at least two electric heating devices firmly together to help production and installation processes and ensure devices held sturdily and neatly.

In the practical implementation, the number of electric devices 1 may be set as 2 to 12. Multiple (2 to 12) electric heating devices 1 are laid sequentially in parallel along the thickness direction of C-shape pipes 23 to meet heating requirements.

The above descriptions, embodiments and figures are only intended to illustrate the basic and main principles and characteristics of the present invention as an example. It is to be noted that various changes and modifications are apparent to those skilled in the art are possible and are within the scope of this invention as defined by the appended claims.

What is claimed is:

1. A multi-curved continuous type metal PTC rapid electric heater comprising: at least one electric heating device having a metal PTC pipe that is enclosed by an electric heating pipe body; wherein both ends of said electric heating pipe body have a wiring terminal in place and outside of said electric heating pipe body has radiating fins installed, the electric heating pipe body of said electric heating device further comprising at least four straight pipes and at least three C-shape pipes;
at the upper end of said straight pipe connected to a said C-shape pipe of which the C opening points downward and the other end of said C-shape pipe connected to another said straight pipe to form a curved electric heating pipe part; and
said electric heating body having at least two said curved electric heating pipe parts, wherein the lower ends of the neighboring straight pipes of two said curved electric heating pipe parts are connected to a said C-shape pipe.

2. A multi-curved continuous type metal PTC rapid electric heater defined in claim 1, wherein said metal PTC pipe and said electric heating pipe body are filled with a heat-conducting electric-insulating powder between them.

3. A multi-curved continuous type metal PTC rapid electric heater defined in claim 1, wherein the number of said curved heating pipe parts is 1 to 10.

4. A multi-curved continuous type metal PTC rapid electric heater defined in claim 2, wherein there is no heating radiating fins installed outside of said C-shape pipes.

5. A multi-curved continuous type metal PTC rapid electric heater defined in claim 4, wherein all said C-shape pipes and all said straight pipes of said electric heating device are laid in the same plane; and
said multi-curved continuous type metal PTC rapid electric heater having at least two electric heating devices being laid sequentially in parallel, front to back along the thickness direction of said C-shape pipes.

6. A multi-curved continuous type metal PTC rapid electric heater defined in claim 5, said electric heating pipe bodies having a plurality of heat radiating fins, wherein two parallel laid said electric heating pipe bodies of at least two said electric heating devices are inserted separately and simultaneously through at least two said radiating fins.

7. A multi-curved continuous type metal PTC rapid electric heater defined in claim 6, wherein the number of electric heating devices is 1 to 12, and said electric heating devices are laid sequentially in parallel, front to back along the thickness direction of C-shape pipes.
